(19) United States
(12) Patent Application Publication
(10) Pub. No.: US 2007/0065271 A1
(43) Pub. Date: Mar. 22, 2007

(54) Control system for a load handling apparatus

(75) Inventors: Peter Merin, Helsinki (FI); Pertti Hellgren, Vihtijarvi (FI)

Correspondence Address: BIRCH STEWART KOLASCH & BIRCH, PO BOX 747, FALLS CHURCH, VA, 22040-0747, US

(73) Assignee: AURAMO OY, Vantaa (FI)

(21) Appl. No.: 11/514,914

(22) Filed: Sep. 5, 2006

(30) Foreign Application Priority Data
Sep. 6, 2005 (FI) 20050878

(51) Int. Cl. B65F 3/26

(52) U.S. Cl. 414/812

(57) ABSTRACT

Load handling apparatus and method for handling loads, like paper rolls or household appliances, wherein the load handling apparatus comprises a vehicle (1) with a hydraulic system (76) controlled by an electronic control system (77), a lifting means (1), a hydraulics user interface (78) for the operator and a gripper arranged in the vehicle's lifting means (11) and provided with arms (6, 7) capable of clamping and lifting a load by applying a compressive force to the load, wherein the gripper is provided with an electric or electronic control system (80), and wherein the gripper's control system is directly connected to the vehicle's hydraulics control system (77) or hydraulics user interface (79) through an electronic interface (73, 90) so that the gripper's control system is capable of controlling the vehicle's hydraulic functions in a similar way as the vehicle's operator using the vehicle's hydraulics user interface (78).

### FIELD OF INVENTION

The present invention relates to a control system and method of a load handling apparatus, wherein the load handling apparatus comprises a vehicle, like a forklift truck, with a hydraulic system controlled by an electronic control system, a lifting means, a hydraulics user interface for the operator and a gripper arranged in the lifting means and provided with arms capable of clamping and lifting the load by applying a compressive force to the load. The present invention relates also to a method of controlling a load handling apparatus.

The present invention relates particularly to a control system of a load handling apparatus and a method for handling easily damageable goods, like paper rolls or household appliances, wherein the load handling apparatus comprises a vehicle, like a forklift truck, with a hydraulic system controlled by an electronic control system, a lifting means, a hydraulics user interface and a gripper arranged in the lifting means and provided with arms capable of clamping and lifting the load by applying a compressive force to the load.

### BACKGROUND OF THE INVENTION

Paper rolls and other goods, like household appliances, may be handled using a gripper mounted on a forklift truck and having arms which are hydraulically compressed against the load. The compressive force produced by the arms can be adjusted manually e.g. to four different settings, depending on the load. Particularly, because of the rough adjustment of the compressive force, the load is often damaged or dropped due to an incorrect compression force.

In order to reduce the risk for damaging the load during the handling action the compressive force necessary for lifting and moving the load, like a paper roll or a household appliance, may be optimized. Such a system is disclosed in U.S. Pat. No. 5,292,219. U.S. Pat. No. 5,292,219 discloses a gripper mounted on a forklift truck designed for the lifting and moving of paper rolls. The gripper is provided with turnable arms with plate-like, hinged contact pads. The compressive force is adjusted on the basis of the movement of the paper roll in respect to the contact pads (relative load movement). The relative load movement is measured by means of slip sensors mounted on the contact pads. The slip sensors are provided with a rotating roller which is held in contact with the paper roll. As the paper roll moves relative to the contact pads, the roller rotates and the slip sensors measure the relative load movement in terms of a pulse count. In U.S. Pat. No. 5,292,219 it is also possible to optimize the compressive force during the whole load handling operation, comprising e.g. the lifting operation, the transfer, the rotation and the lowering of the load. The relative load movement is measured continuously and if any relative load movement is detected, the effective compressive hydraulic pressure (compressive force) between the contact pads and the paper roll is increased automatically until the relative load movement has been stopped.

The apparatus is provided with suitable hydraulic valves arranged in the forklift truck for controlling the hydraulic oil to flow into the forklift truck's lift cylinder (prelift) during the initial clamping action performed by the operator and for automatically controlling throughout the entire load handling operation the effective compressive hydraulic pressure over the gripper's clamping cylinders in case relative load movement is detected. The hydraulic valves may in some cases interfere with the operation of the hydraulic system of the forklift truck. Furthermore they are bulky, high priced and cause pressure loses in the forklift truck's hydraulic system.

### THE PRESENT INVENTION

It is an object of the present invention to provide an improved control system and a control method for a load handling apparatus. The present invention provides a new control system for a load handling apparatus comprising a vehicle with a hydraulic system controlled by an electronic control system, a lifting means, a hydraulics user interface and a gripper provided with arms capable of clamping and lifting the load by applying a compressive force to the load.

The present invention is based on the idea that the control system of the vehicle's hydraulic system and the control system of the gripper are connected directly together through an electronic interface which creates a “virtual operator” that is capable of controlling the vehicle's hydraulic functions electronically in a similar way as the “real operator” (operator) controls them manually using the vehicle's hydraulics user interface (e.g. joysticks).

The invention is defined in claim 1 as follows:

The control system of a load handling apparatus for handling loads, like paper rolls or household appliances, wherein the load handling apparatus comprises a vehicle with a hydraulic system controlled by an electronic control system, a lifting means, a hydraulics user interface (e.g. joysticks) for the operator and a gripper arranged in the lifting means and provided with arms capable of clamping the load by applying a compressive force to the load, wherein the gripper is be provided with an electronic or electric control system, whereby the invention is characterised in that the gripper's control system is connected directly with an interface to the vehicle's hydraulics control system in such a way that the gripper's control system is capable of controlling electronically as a “virtual operator” the vehicle's hydraulic functions essentially in the same way as the forklift truck operator (“real operator”) is controlling them manually with the hydraulics user interface.

In a preferred embodiment of the present invention the “virtual operator” has a lower priority level than the “real operator”, i.e. the actions of the “real operator” always override the actions of the “virtual operator”. The “virtual operator” is automatically de-activated when ever the “real operator” is manually controlling the vehicle's hydraulic functions with the hydraulics user interface. Other characteristic features of the present invention are presented in the enclosed claims.

The advantage of the present invention is that no additional hydraulic valves need to be installed in to the vehicle's hydraulic system for delivering hydraulic pressure to the gripper when requested by the gripper's control system. Consequently the system performance is improved, the installation and commissioning times are shortened, hydraulic pressure loses are reduced and cost effectiveness is improved.

### BRIEF DESCRIPTION OF DRAWINGS

The foregoing, and additional objects, features and advantages of the present invention will be more clearly understood from the following detailed description of preferred embodiments of the present invention, taken in conjunction with accompanying drawings, in which:

FIG. 1 presents a conventional forklift truck provided with a gripper according to the present invention,

FIG. 2 presents a hydraulic system of a load handling apparatus (conventional) in which the vehicle's hydraulics control system is not directly connected through an interface to the gripper's control system. Hydraulic pressure is delivered to the gripper by means of additional hydraulic valves installed into the vehicle's hydraulic system.

FIG. 3 presents a hydraulic system of a load handling apparatus according to the present invention.

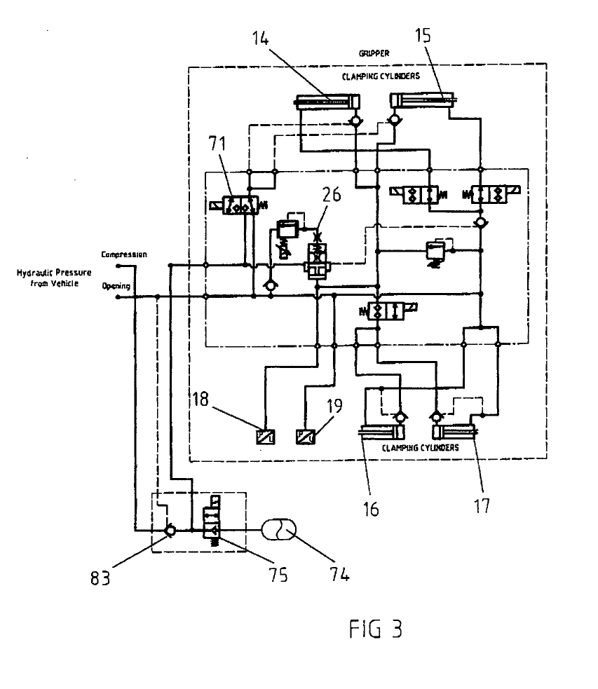

FIG. 4 presents the flow chart of the operation of a conventional load handling apparatus (FIG. 4A) and a load handling apparatus according to the present invention (FIG. 4B).

### DETAILED DESCRIPTION OF THE INVENTION

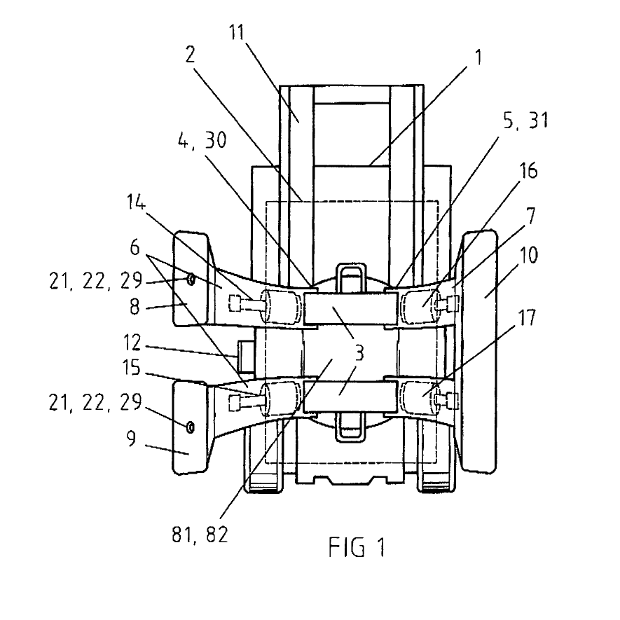

FIG. 1 shows a load handling apparatus comprising a forklift truck 1 provided with a hydraulic system 76 controlled by an electronic control system 77, a lifting means 11, a gripper user interface 28, a hydraulics user interface 78 to the forklift truck's hydraulics control system e.g. joysticks for using the forklift truck's hydraulic functions and a gripper designed for lifting and moving paper rolls 2 or other loads. The gripper is mounted on the lifting means and is provided with hydraulic clamping cylinders 14-17 and turnable arms 6, 7 attached to a frame 3, the pivot point of the arms being located at points 4, 5. One side of the gripper's arms can be split 6 and the other non-split 7; the tips of the arms are provided with plate-like, hinged contact pads 8-10 which grip the load. The frame can accommodate a hydraulic system comprising a rotation mechanism 81 with hydraulic cylinders 82 for turning the arms and a hydraulic valve block 12 for controlling the operation of the gripper.

The gripper is further provided with slip sensors 21 mounted on contact pads 8, 9. Each sensor is provided with a roller 22 rotating on an axle and held in contact with the load by a spring. The grippers can be further provided with displacement sensors 30, 31 arranged in the pivot points 4, 5 in order to measure the angle/position and the movement of the arms.

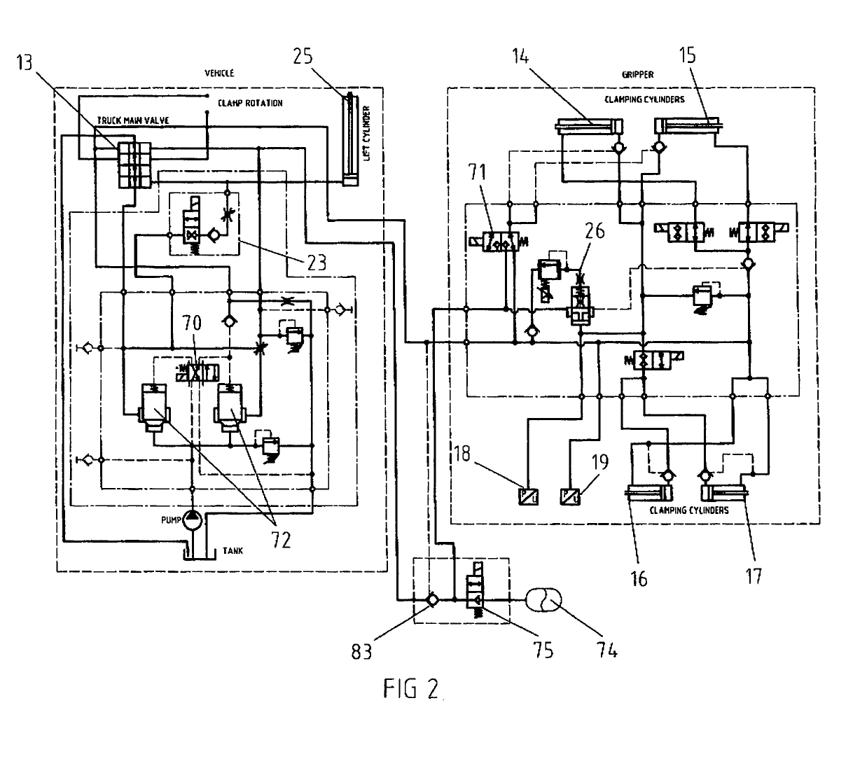

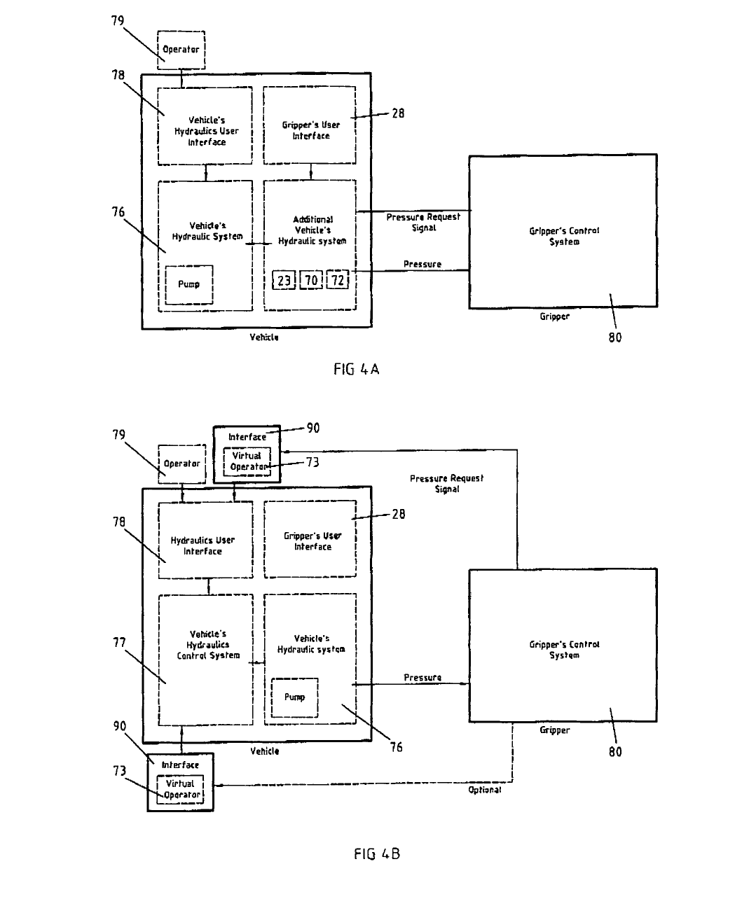

The operating cycle begins when the forklift truck brings the gripper close to the load in such a way that the gripper arms come on opposite sides of the load. Compression is started when the forklift truck's operator uses the vehicle's hydraulics user interface 78 to activate valve 13 in the vehicle in order to open the arms FIG. 2, FIG. 4. Hydraulic oil now flows directly into the gripper's clamping cylinders closing the arms until they are in contact with the load. When the effective compressive hydraulic pressure measured by the pressure sensors 18, 19 exceeds a predetermined value, the gripper's control system starts the detection of the load movement in respect to the contact pads (relative load movement). The relative load movement is detected and measured by means of the slip sensors. As the load moves relative to the contact pads the roller rotates and the slip sensor measures the relative load movement in terms of a pulse count.

Simultaneously with the measurement of the relative load movement, an optional slow lifting action (prelift) may be activated. In order to start the prelift the gripper's control system sends a pressure request (open signal) to hydraulic valve 23, permitting the flow of a controlled amount of hydraulic oil into the forklift truck's lift cylinder 25 located in the lifting means 11. The automatic prelift enables a quick and precise pressure control. Hydraulic valve 23 may also be connected in a different way from FIG. 2.

Based on the relative load movement and the input from pressure sensors the gripper's control system controls a proportional valve 26 which is adjusting the effective compressive hydraulic pressure over the clamping cylinders FIG. 2. The effective compressive hydraulic pressure is increased until the gripper holds the load firmly and no more relative load movement is detected. When the relative load movement has ceased, the control system stops increasing the effective compressive hydraulic pressure and a signal light or alike in the gripper's user interface 28 signals the operator that the clamping operation has been completed successfully. The operator may then use the vehicle's hydraulics user interface 78 to close valve 13 and continue with any desired handling actions FIG. 2, FIG. 4.

The gripper's control system remains active during the entire handling sequence. In case the load moves in any direction in respect to the contact pads e.g. as a result of dynamic loads the gripper's control system reacts automatically to stop the relative load movement by increasing the effective compressive hydraulic pressure acting over the clamping cylinders. To accomplish this the gripper's control system send a pressure request (activation signal) to hydraulic valve 70 which is installed into the vehicle's hydraulic system FIG. 2. Once activated hydraulic valve 70 and hydraulic valves 72 pressurize the vehicle's hydraulic system which allows the flow of hydraulic oil through the proportional valve 26 to the clamping cylinders. Consequently the compressive force produced by clamping cylinders will increase until the relative load movement has been stopped. The setting of the proportional valve is continuously controlled by the gripper's control system based on the relative load movement.

As a configuration option, once the relative load movement has been stopped, the gripper's control system may be directed to reduce the effective compressive hydraulic pressure acting over the clamping cylinders (compressive force) back towards the pressure that was present in the clamping cylinders prior to the automatic increase. To accomplish this the gripper's control system reactivates hydraulic valves 70, 72 as well as hydraulic valve 71 with a pressure request and simultaneously reduces the electrical drive signal to the proportional valve 26. After the effective compressive hydraulic pressure (compressive force) has been reduced to a desirable level, hydraulic valves 70, 72 are de-activated. Hydraulic valve 71) can be de-activated or left activated depending on the application.

According to the present invention, the gripper's control system is connected through an electronic interface 73 directly to the vehicle's hydraulics control system e.g. through the vehicle's hydraulics user interface e.g. joysticks 78 that are normally used manually by the vehicle's operator to control oil flow from the vehicle to the gripper or other attached hydraulic devices. Thereby a “virtual operator” 80 is created that is capable of controlling the vehicle's hydraulic functions in a similar manner as the “real operator” 79 using manually the vehicle's hydraulics user interface 78. Upon pressure requests from the gripper's control system, the “virtual operator” is e.g. capable of activating the vehicle's hydraulics control system for initiating the prelift during the handling of the load as well as directing hydraulic oil to the clamping cylinders in case relative load movement is detected during the handling sequence. The “virtual operator” has, however, a lower priority than the “real operator” i.e. the “real operator” always overrides the “virtual operator”. The “virtual operator” is automatically de-activated when ever the “real operator” is controlling manually the vehicle's hydraulic functions.

The present invention allows the gripper's pressure control system to operate without the need of installing any additional hydraulic valves 23, 70, 71, 72 into the vehicle's hydraulics system. This will enhance the overall performance of the load handling apparatus, shorten the installation and commissioning times, reduce the overall energy consumption and improve cost effectiveness. In order to enhance the operation of the gripper's pressure control system as described in the present invention an additional hydraulic pressure accumulator 74 and accumulator control valves 75, 83 can be installed in the gripper or in the vehicle FIG. 2. The purpose of the pressure accumulator is to act as a reservoir of hydraulic pressure in case the vehicle's hydraulic pump experiences delays in producing the necessary compressive hydraulic pressure. If the pressure accumulator is used, the “virtual operator” send a pressure request to the accumulator control valve 75 to open it when relative load movement is detected during handling. This discharges high velocity hydraulic oil from the pressure accumulator through the proportional valve 26 to the gripper's clamping cylinders in order to quickly increase the compressive force. As the hydraulic pressure produced by the vehicle's pump increases, the direction of oil flow in the accumulator changes and the accumulator will be automatically re-charged as the vehicle's hydraulic pumps becomes the gripper's primary source of hydraulic oil and pressure.

It is obvious to a person skilled in the art that the invention is not restricted to the example described above, but that it may instead be varied within the scope of the following claims. Instead of a forklift truck some other type of vehicles provided with corresponding hydraulic systems may be used. Similarly instead of a gripper's control system based on the relative load movement as presented in the example above any kind of electronic or electric control system capable of sending pressure requests to the “virtual operator” can be used. In addition the interface between the vehicle's hydraulics control system and the gripper's control system (“virtual operator”) can be analogy or digital (e.g. CAN-bus, Bluetooth or Wlan).

1. Load handling apparatus for handling loads, like paper rolls or household appliances, wherein the load handling apparatus comprises a vehicle (1) with a hydraulic system (76) controlled by an electronic control system (77), a lifting means (1), a hydraulics user interface (78) for the operator and a gripper arranged in the vehicle's lifting means (11) and provided with arms (6, 7) capable of clamping and lifting a load by applying a compressive force to the load, wherein the gripper is provided with an electric or electronic control system (80), characterized in that the gripper's control system is directly connected to the vehicle's hydraulics control system (77) or hydraulics user interface (79) through an electronic interface (73, 90) so that the gripper's control system is capable of controlling the vehicle's hydraulic functions in a similar way as the vehicle's operator using the vehicle's hydraulics user interface (78).

2. Control system for a load handling apparatus according to claim 1, characterized in that the interface between the vehicle and the gripper (90) is analog.

3. Control system for a load handling apparatus according to claim 1, characterized in that the interface between the vehicle and the gripper (90) is digital.

4. Method of a control system of a load handling apparatus for handling loads, like paper rolls or household appliances, wherein the load handling apparatus comprises a vehicle (1) with a hydraulic system (76) controlled by an electronic control system (77), a lifting means (11), a hydraulics user interface for the operator (78) and a gripper arranged in the vehicle's lifting means and provided with arms (6, 7) capable of clamping and lifting a load (2) by applying a compressive force to the load, wherein the gripper is provided with an electronic control system (80), characterized in that the gripper's control system (80) is directly connected the vehicle's hydraulic control system (77) or hydraulics user interface (79) through an interface (73, 90) so that the gripper's control system is capable of controlling the vehicle's hydraulic functions in a similar way as the vehicle's operator (“real operator”) using the vehicle's hydraulics user interface.

5. Method according to claim 4 characterized in that the control actions of the “real operator” (79) always overrides the control actions of the “virtual operator” (73).

6. Method according to claim 4 characterized in that the gripper detects the movement of the load in respect to the gripper (relative load movement), whereby the compressive force applied to the load is adjusted on the basis of the relative load movement measured with one or more slip sensors (21) between the load (2) and the contact pads (8-10) which are attached to the arms (6, 7), whereby the gripper's control system (80) adjusts the effective compressive hydraulic pressure acting over the clamping cylinders (14-17) based on the amount of relative load movement,
whereby the effective compressive hydraulic pressure (compressive force) is increased until the gripper holds the load firmly and the relative load movement has been stopped,
whereby the gripper's control system (80) stops increasing the effective compressive hydraulic pressure (compressive force) and a control light or similar in the gripper's user interface (28) signals the “real operator” (79) that a sufficient compressive force has been applied and that the relative load movement has been stopped, where after the “real operator” may perform any desired handling action, and
whereby the gripper's control system (80) is capable of reducing down the effective compressive hydraulic pressure (compressive force) to a predefined level after increasing the effective compressive hydraulic pressure (compressive force) as a result of relative load movement.

7. Method according to claim 4, characterized in that the method may include a controlled lifting action (prelift), whereby the gripper's control system instructs the “virtual user” to supply a controlled flow of hydraulic oil through hydraulic valve (23) into the vehicle's lift cylinder after the contact pads (8-10) in the arms (6, 7) have proper contact with the load.

8. Method according to claim 4, characterized in that the method may include an additional reservoir of pressurized hydraulic oil (74), e.g. a hydraulic pressure accumulator, whereby the gripper's control system activates hydraulic valve (75) to allow rapid oil flow from pressure accumulator (74) throught proportional valve (26) to the clamping cylinders (14-17) until the hydraulic pressure produced by the vehicle's hydraulic pump has reached a suitable level.

9. Method according to claim 6, characterized in that the method may include a controlled lifting action (prelift), whereby the gripper's control system instructs the “virtual user” to supply a controlled flow of hydraulic oil through hydraulic valve (23) into the vehicle's lift cylinder after the contact pads (8-10) in the arms (6, 7) have proper contact with the load.

10. Method according to claim 6, characterized in that the method may include an additional reservoir of pressurized hydraulic oil (74), e.g. a hydraulic pressure accumulator, whereby the gripper's control system activates hydraulic valve (75) to allow rapid oil flow from pressure accumulator (74) throught proportional valve (26) to the clamping cylinders (14-17) until the hydraulic pressure produced by the vehicle's hydraulic pump has reached a suitable level.

11. Method according to claim 7, characterized in that the method may include an additional reservoir of pressurized hydraulic oil (74), e.g. a hydraulic pressure accumulator, whereby the gripper's control system activates hydraulic valve (75) to allow rapid oil flow from pressure accumulator (74) throught proportional valve (26) to the clamping cylinders (14-17) until the hydraulic pressure produced by the vehicle's hydraulic pump has reached a suitable level.
